(19) United States
(12) Patent Application Publication
(10) Pub. No.: US 2012/0203929 A1
(43) Pub. Date: Aug. 9, 2012

(54) VISUAL PREVIEW OF SHORTENED URL

(75) Inventor: Gary Patalsky, Arlington, VA (US)

(73) Assignee: KPI GLOBAL TECHNOLOGIES, INC., Arlington, VA (US)

(21) Appl. No.: 13/193,403

(22) Filed: Jul. 28, 2011

Related U.S. Application Data
(60) Provisional application No. 61/439,287, filed on Feb. 3, 2011.

(51) Int. Cl. G06F 15/16

(52) U.S. Cl. 709/245

(57) ABSTRACT

One example embodiment includes a system for previewing a shortened URL. The system includes a preview coordinator. The preview coordinator is configured to resolve a shortened URL, where resolving the shortened URL includes determining a standard URL which is linked to by the shortened URL. The preview coordinator is also configured to generate a preview of the standard URL, where generating a preview of the standard URL includes creating an image of the location referenced by the standard URL. The preview coordinator is further configured to display the preview of the standard URL to a user.

### CROSS-REFERENCE TO RELATED APPLICATIONS

This application claims the benefit of and priority to U.S. Provisional Patent Application Ser. No. 61/439,287 filed on Feb. 3, 2011, which application is incorporated herein by reference in its entirety.

### BACKGROUND OF THE INVENTION

Shortened Uniform Resource Locators (URLs) are becoming increasingly popular. They allow standard URLs, which can be quite long, to be shared more easily. In fact, some standard URLs are long enough that they cannot be shared using some forms of communication. For example, Twitter and many types of text messaging are limited to 140 characters. By using URL shortening service, long URLs can be shared using far fewer characters.

However, there is a drawback to using shortened URLs. In particular, they can direct users to sites that are potentially dangerous or fraudulent. For example, they may direct the user to a site where the user's computer becomes infected with a virus or that downloads malware to the user's computer. Alternatively, the shortened URL might not take the user to a site that is dangerous but instead take the user to a site that is designed to annoy the user. For example, “rick rolling” is a common online practical joke where users are directed to a site under false pretenses.

To alleviate these problems, standard URLs can be “previewed”. I.e., the user can often place his/her cursor over the URL and a small window will open showing the webpage that will be opened if the URL is selected. However, shortened URLS lack this ability. This is because the shortened URL directs the user to the URL shortening website, which resolves the shortened URL into a standard URL and displays the standard URL to the user. Therefore, previewing the shortened URL will preview the URL shortening service, rather than the standard URL.

Accordingly, there is a need in the art for a system that is capable of previewing a shortened URL.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for previewing a shortened URL. The system includes a preview coordinator. The preview coordinator is configured to resolve a shortened URL, where resolving the shortened URL includes determining a standard URL which is linked to by the shortened URL. The preview coordinator is also configured to generate a preview of the standard URL, where generating a preview of the standard URL includes creating an image of the location referenced by the standard URL. The preview coordinator is further configured to display the preview of the standard URL to a user.

Another example embodiment includes a system for previewing a shortened URL. The system includes a preview coordinator and a URL resolver, where the URL resolver resolves a shortened URL into a standard URL. The preview coordinator instructs the URL resolver to resolve the shortened URL in response to a user action. The system also includes a preview fetcher, where the preview fetcher generates a preview of the standard URL. The preview coordinator instructs the preview fetcher to generate the preview of the standard URL after receiving the standard URL from the URL resolver and displays the preview to the user.

Another example embodiment includes a method of previewing a shortened URL for a user. The method resolving a shortened URL, where resolving a shortened URL includes determining a standard URL which is linked to by the shortened URL. The method also includes generating a preview of the standard URL, where generating a preview of the standard URL includes creating an image of the location referenced by the standard URL. The method further includes displaying the preview of the standard URL to a user.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for visual preview of a web page with a shortened URL;

FIG. 2 is a block diagram illustrating an example of a system for generating a visual preview of a shortened URL;

FIG. 3 is a flowchart illustrating an example of a method for previewing a shortened URL; and

FIG. 4 illustrates an example of a graphical user interface for displaying a visual preview of a web page with a shortened URL.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

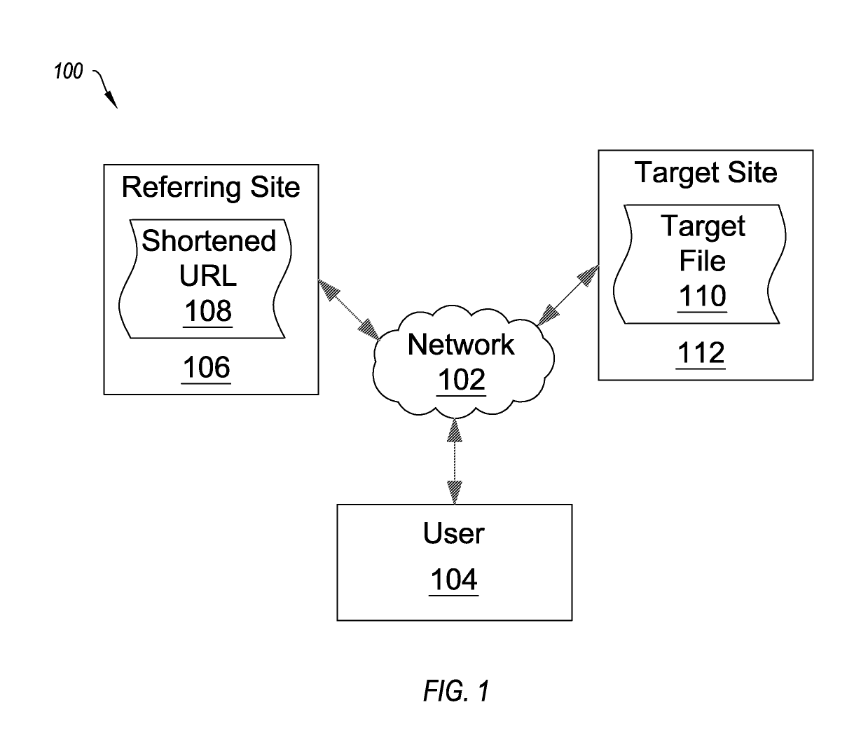

FIG. 1 illustrates a block diagram of a system 100 for visual preview of a web page with a shortened URL. In at least one implementation, the system 100 allows a user to preview a target file before opening the target file. In particular, the system 100 allows a user to determine the nature and content of the target file before opening the target file.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. The network 102 can also include servers that enable one type of network to interface with another type of network.

FIG. 1 also shows that the system 100 can include a user 104 connected to the network 102. In at least one implementation, the user 104 can include any entity connected over the network 102. For example, the user 104 can include an individual surfing the Web. Additionally or alternatively, the user 104 can include a device, embodied in either software or hardware, which is connected to the network 102.

In at least one implementation, the user 104 is connecting to a file over the network 102. For example, user 104 can navigate to Uniform Resource Locators (“URLs”) or databases using the network 102. It should be noted that “URL” as used herein refers to any network file, including domains, subdomains, Web posts, Uniform Resource Identifiers (“URIs”), web pages, images, videos, or other piece of content and non-permanent postings such as e-mail and chat unless otherwise specified. One skilled in the art will appreciate, however, that any delivery system of a file to the user 104 is within the scope of the invention. Therefore, the delivery method of the file to the user 104 should not be seen as limiting the invention, as described herein, unless otherwise specified in the claims.

FIG. 1 further shows that the system 100 can include a referring site 106. In at least one implementation, the referring site 106 can include the location of a file or other resource in a database or other storage media. I.e., the referring site 106 can include a file that the user 104 is accessing. The file is transferred over the network 102 to the user 104 either in total or in packets. The user 104 can then view or otherwise use the file. The user 104 can make changes to the file which are saved locally or saved to the referring site 106 over the network 102. One skilled in the art will appreciate, that a user 104 can connect to the network 102 for connection to any referring site 106 without restriction. Therefore, the content sought by the user 104 on the referring site 106 should not be seen as limiting the invention, as described herein, unless otherwise specified in the claims.

FIG. 1 additionally shows that the system 100 can include a shortened URL 108. In at least one implementation, the shortened URL 108 includes a reference to a target file 110. I.e., the shortened URL 108 includes information about an additional file which the user 104 may wish to access. For example, the shortened URL 108 can include a hyperlink. A hyperlink (or link) is a reference to a file that the reader can directly follow, or that is followed automatically. The hyperlink can point to a whole file or to a specific element within a file. The hyperlink can include an anchor, which is the location within the file from which the hyperlink can be followed. I.e., the anchor can include text or images which the user 104 can select, usually by touching or clicking on the anchor with a pointing device, which indicates a desire by the user 104 to access the target file 110.

A shortened URL is a condensed URL which redirects to a standard URL. I.e., a shortened URL is a URL which points, either directly or indirectly, to the same target file 110 as the standard URL but uses fewer characters within the anchor. Shortened URLs are widely used in communication mediums where the length of message is severely limited. Examples are Twitter and cellular telephone text messaging both of which allow only 140 characters per message. A shortened URL is typically generated by a URL shortening service.

In at least one implementation, a URL shortening service generates shortened URLs. Examples of URL shortening services include http://bit.ly, http://www.goo.gl, http://t.co and http://tinyurl.com. The shortened URL can point to an intermediate file which in turn points to the target file 110. I.e., when the shortened URL is selected by the user the URL shortening service can resolve the shortened URL into the standard URL. For example, bit.ly is a URL shortening service which condenses the Standard URL http://www.uspto.gov/patents/process/search to the Shortened URL http://biUy/azNzKd. If a user accesses http://biUy/azNzKd, bit.ly will redirect the user to http://www.uspto.gov/patents/process/search.

FIG. 1 also shows that the system 100 can include a target site 112. In at least one implementation, the target site 112 can include the location of the target file 110. I.e., the target file 110 can be located on the target site 112. As the user 104 selects the shortened URL 108 the user is redirected over the network 102 from the referring site 106 to the target site 112. One of skill in the art will appreciate that the target site 112 and the referring site 106 can be different sites or can be the same site. I.e., the referring site 106 and the target site 106 can be the same database which stores both the shortened URL 108 and the target file 110.

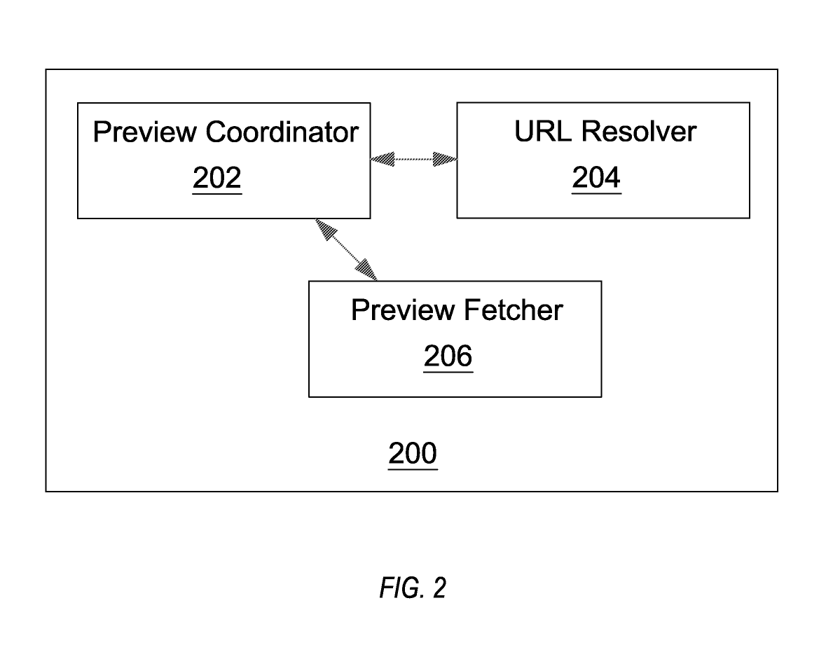

FIG. 2 is a block diagram illustrating an example of a system 200 for generating a visual preview of a shortened URL. In at least one implementation, the system 200 is capable of allowing a user to preview a target file referenced by a shortened URL before being redirected to the target file. I.e., currently, users click on a shortened URL, taking user to the actual target file represented by the shortened URL. This shortened URL could redirect to a legitimate site or to a site with viruses or spam (the shortened URL masks the true destination). For example, consider the bit.ly URL shortening service, in which all shortened links are of the format http://bit.ly/[randomSeguence]. The shortened URLs do not indicate the page to which the shortened URL points. I.e., http://bit.ly/c1htE can point to http://en.wikipedia.org/wiki/URL_shortening, http://bit.ly/azNzKd can point to http://www.uspto.gov/patents/process/search and http://bit.ly/[seguence] can point to a site with a virus.

The system 200 can be implemented using software, hardware or any combination thereof. If the system 200 is implemented using software, the steps of the system 200 can be stored in a computer-readable medium, to be accessed as needed to perform their functions. Additionally, if the system 200 is implemented using software, the steps can be carried out by a processor, field-programmable gate array (FPGA) or any other logic device capable of carrying out software instructions or other logic functions.

FIG. 2 shows that the system 200 can include a preview coordinator 202. In at least one implementation, the preview coordinator 202 can prepare a visual preview of the target file for the user. I.e., when the user requests a preview of the shortened URL the preview coordinator 202 prepares the visual preview and then displays it to the user. The user requests a preview of a shortened URL by hovering over the link, by clicking a nearby preview indicator or otherwise indicating that the user desires to see a visual preview.

FIG. 2 also shows that the system 200 can include a URL resolver 204. In at least one implementation, the URL resolver 204 converts the shortened URL into a standard URL. For example, the URL resolver 204 can access the file that the shortened URL points to in order to locate the target file. The preview coordinator 202 can request that the URL resolver 204 convert the shortened URL to the standard URL. Additionally or alternatively, the URL resolver 204 can return the standard URL to the preview coordinator 202.

FIG. 2 further shows that the system 200 can include a preview fetcher 206. In at least one implementation, the preview fetcher 206 can generate a preview of the standard URL. In particular, the preview fetcher 206 can access the target file and render the target file to an image using the appropriate protocol. The preview coordinator 202 can request a preview of the standard URL from the preview fetcher 206. Additionally or alternatively, the preview fetcher 206 can return the preview to the preview coordinator 202.

In at least one implementation, the preview coordinator 202 can display the preview to user. In particular, the preview coordinator 202 can display the image returned by the preview fetcher 206. The user can then see a preview of the target file before determining whether to access the target file. In the case of the World Wide Web browser, the preview coordinator dynamically modifies the document object model (DOM).

One of skill in the art will appreciate that one or more of the components of the system 200 can be combined or dividing into multiple components. For example, the URL resolver 204 can be combined with the preview fetcher 206. E.g., if the URL shortening service provides a preview the URL resolver 204 can return the preview to the preview coordinator 202 without directly accessing the target file. Alternatively, the URL resolver 204 can locate the standard URL, access the target file, prepare a preview image and return the image to the preview coordinator 202.

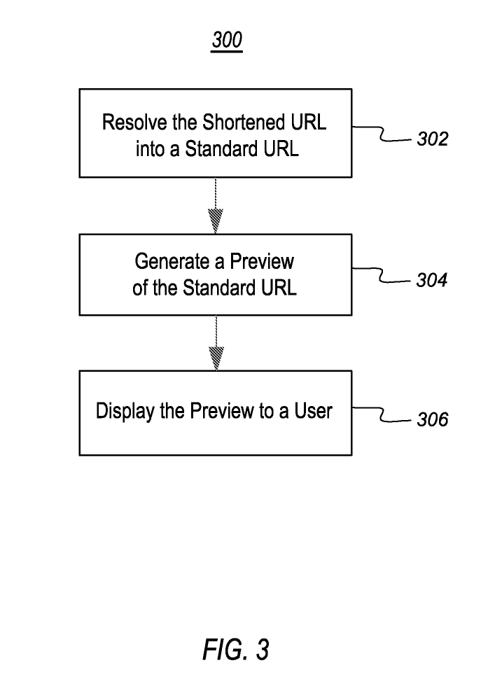

FIG. 3 is a flowchart illustrating an example of a method 300 for previewing a shortened URL. In at least one implementation, the method 300 can allow the user to view the target file to which the user will be directed without selecting the link. The method 300 can be implemented using a system such as the system 200 of FIG. 1. Therefore, the method 300 will be described, exemplarily, with reference to the system 200 of FIG. 2. Nevertheless, one of skill in the art will appreciate that the method 300 can be used with a system other the system 200 of FIG. 2.

FIG. 3 shows that the method 300 includes resolving the shortened URL into a standard URL 302. In at least one implementation, the shortened URL can be resolved into the standard URL by a URL resolver 204. For example, the URL resolver 204 can access the file that the shortened URL points to in order to locate the target file. The preview coordinator 202 can request that the URL resolver 204 convert the shortened URL to the standard URL. Additionally or alternatively, the URL resolver 204 can return the standard URL to the preview coordinator 202.

FIG. 3 also shows that the method 300 includes generating a preview of the standard URL 304. In at least one implementation, the preview fetcher 206 can generate a preview of the standard URL. In particular, the preview fetcher 206 can access the target file and render the target file to an image using the appropriate protocol. The preview coordinator 202 can request a preview of the standard URL from the preview fetcher 206. Additionally or alternatively, the preview fetcher 206 can return the preview to the preview coordinator 202.

FIG. 3 further shows that the method 300 includes displaying the preview to a user 306. In at least one implementation, the preview coordinator 202 can display the preview to user. In particular, the preview coordinator 202 can display the image returned by the preview fetcher 206. The user can then see a preview of the target file before determining whether to access the target file. In the case of the World Wide Web browser, the preview coordinator dynamically modifies the DOM.

The method 300 can be implemented using software, hardware or any combination thereof. If the method 300 is implemented using software, the steps of the method 300 can be stored in a computer-readable medium, to be accessed as needed to perform their functions. Additionally, if the method 300 is implemented using software, the steps can be carried out by a processor, field-programmable gate array FPGA or any other logic device capable of carrying out software instructions or other logic functions.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

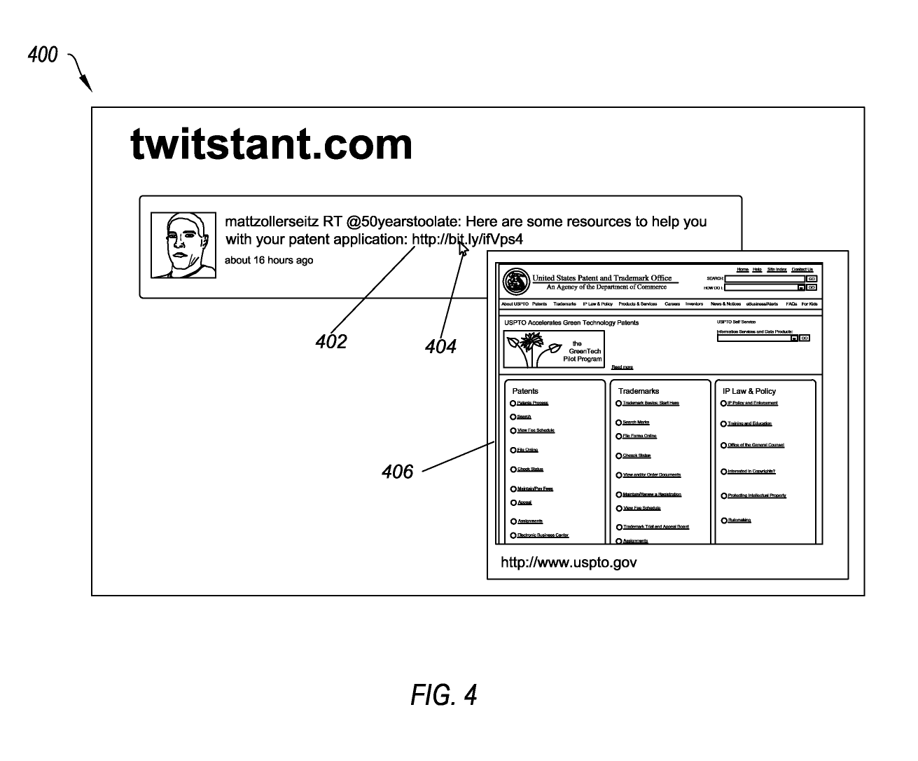

FIG. 4 illustrates an example of a graphical user interface (GUI) 400 for displaying a visual preview of a web page with a shortened URL. In at least one implementation, the GUI 400 (sometimes pronounced gooey) is a type of user interface that allows users to interact with electronic devices with images rather than text commands. The GUI 400 can be used in computers, hand-held devices such as MP3 players, portable media players or gaming devices, cell phones, household appliances and office equipment. The GUI 400 represents the information and actions available to a user through graphical icons and visual indicators such as secondary notation, as opposed to text-based interfaces, typed command labels or text navigation. The actions are usually performed through direct manipulation of the graphical elements.

FIG. 4 shows that the GUI 400 includes a shortened URL 402. In at least one implementation, the shortened URL 402 directs the user to a target file. For example, the GUI 400 can include a webpage which has a shortened URL 402 pointing to another webpage. E.g., the GUI 400 can include a twitter feed in which the user has tweeted a link to an external webpage.

FIG. 4 also shows that the GUI 400 can include an option 404 for a user to select a visual preview. For example, the option 404 can include the user hovering over the shortened URL 402 or by clicking a nearby link, such as a button, to show a visual preview. For example, as a user is viewing an Internet World Wide Web page which contains a shortened URL 402 the user can mouse over the shortened URL 402 to indicate a desire for a visual preview.

FIG. 4 further shows that the GUI 400 can include an image 406. In at least one implementation, the image 406 shows the target file pointed to by the shortened URL 402. In particular, the image 406 can include a rendering of the target file, as described above. The image 406 can be displayed within the current file. In particular, the target file can be displayed near the shortened URL 402 or near the option 404 selected by the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for previewing a shortened URL, the system comprising:
a preview coordinator, wherein the preview coordinator is configured to:
resolve a shortened URL, wherein resolving the shortened URL includes determining a standard URL which is linked to by the shortened URL;
generate a preview of the standard URL, wherein generating a preview of the standard URL includes creating an image of the location referenced by the standard URL; and
display the preview of the standard URL to a user.

2. The system of claim 1, wherein resolving the shortened URL includes sending a request to a URL shortening service.

3. The system of claim 2, wherein the URL shortening service created the shortened URL.

4. The system of claim 2, wherein the URL shortening service returns the standard URL.

5. The system of claim 1, wherein the location referenced by the standard URL includes a target file.

6. The system of claim 1, wherein the location referenced by the standard URL includes a webpage.

7. The system of claim 1 further comprising a URL resolver.

8. The system of claim 7, wherein the preview coordinator instructs the URL resolver to resolve the shortened URL into the standard URL.

9. The system of claim 1 further comprising a preview fetcher.

10. The system of claim 9, wherein the preview coordinator instruct the preview fetcher to generate the preview of the standard URL.

11. A system for previewing a shortened URL, the system comprising:
a preview coordinator;
a URL resolver, wherein the URL resolver resolves a shortened URL into a standard URL;
wherein the preview coordinator instructs the URL resolver to resolve the shortened URL in response to a user action;
a preview fetcher, wherein the preview fetcher generates a preview of the standard URL; and
wherein the preview coordinator:
instructs the preview fetcher to generate the preview of the standard URL after receiving the standard URL from the URL resolver; and
displays the preview to the user.

12. The system of claim 11 further comprising a graphical user interface.

13. The system of claim 12, wherein the shortened URL is displayed to the user on the graphical user interface.

14. The system of claim 12, wherein the user requests the preview using the graphical user interface.

15. The system of claim 12, wherein the preview is displayed to the user on the graphical user interface.

16. A method of previewing a shortened URL for a user, the method comprising:
resolving a shortened URL, wherein resolving a shortened URL includes determining a standard URL which is linked to by the shortened URL;
generating a preview of the standard URL, wherein generating a preview of the standard URL includes creating an image of the location referenced by the standard URL; and
displaying the preview of the standard URL to a user.

17. The system of claim 16 further comprising receiving a request from the user to preview the shortened URL.

18. The system of claim 17, wherein the user initiates the request by hovering a pointer over the shortened URL.

19. The system of claim 17, wherein the user initiates the request by clicking a button.

20. The system of claim 20, wherein the button includes an image.
